(19) United States
(12) Patent Application Publication
(10) Pub. No.: US 2002/0149897 A1
(43) Pub. Date: Oct. 17, 2002

(54) POWER SUPPLY PROTECTIVE DEVICE FOR CARS

(76) Inventor: Chun-Liang Liu, Taipei Hsien (TW)

Correspondence Address: THOMAS M. FREIBURGER, 25th FLOOR, 650 CALIFORNIA ST., SAN FRANCISCO, CA, 94108, US

(21) Appl. No.: 09/834,120

(22) Filed: Apr. 11, 2001

(51) Int. Cl. H02H 7/00

(52) U.S. Cl. 361/104

(57) ABSTRACT

This power supply protective device for cars can be used to protect electric appliances when they are connected to cars. Such a protective device can protect expensive electric appliances used in cars such as laptop computers. When these appliances are in use, they make use of the extended power supply from the cigar-lighter base in cars. This invention can protect such a power supply source. The invention uses a simple inserting/connecting structure to wrap the thin lock-piece fuse inside and then insert it into the cigar-lighter base. Moreover, it is very easy to change fuses.

### FIELD OF THE INVENTION

This invention is about a protective device, especially a protective device to guard the extended power supply for the light switch base inside cars when it is connected to other electric appliance.

### BACKGROUND OF THE INVENTION

Cars have become a dispensable kind of transportation means for people nowadays. When driving, car drivers have to concentrate 100%. Passengers usually take opportunities to have a rest. In today's busy metropolitan life, many people make a good use of the time they get jammed in traffic. Completing unfinished work in a car is common and doing this allows people to have more free time once they get home. When completing unfinished work in cars, many people turn on their laptop computers or mobile phones. Then, they have to use the car power supply as the power source. However, sometimes when users try to plug a power cord into the socket, several factors will affect the performance of the laptop computer and mobile phones or even damage them. These factors are unstable power voltage, a short circuit or other improper use. Moreover, the use of these expensive items sometimes bums out the circuit for cigar-lighter in cars. It ends up bringing a loss to the car owner and he/she has to spend the money on repair. Car owners lose both money and time in such a situation.

To solve the above problem, people in car industry introduce a protective advice that assembles the purchase parts in form of welding, assembling and installing. Finally with traditional cylinder fuse, these purchased parts will form a protective device to guard electric appliances. Nevertheless, during assembly, following problems may happen:

1. Such a device has many complicated parts. Sometimes, during assembly, parts may get lost and this makes it hard for the assembly to proceed.

2. Assembling a complicated device requires other tools such as a welding iron and soldering tin. This approach is not only effort-consuming and also brings much inconvenience.

3. Such a traditional cylinder fuse is really big and it is hard to change.

From the above descriptions, it is clear that the traditional device has a lotof problems and needs improvement.

The author of this invention has brought about an improved version to address the problems of the traditional power supply protective device for cars. With years of efforts, the author finally successfully completed this invention.

### SUMMARY OF THE INVENTION

The purpose of this invention is to provide a power supply protective device for cars. With a simple inserting structure, insert a thin lock-piece of covered fuse into the cigar-lighter base in the car as the protective device between the cigar-lighter base and the electric appliance. This set-up can prevent the damage done to expensive electric appliances.

The second purpose of this invention is to provide a power supply protective device for cars. One of the special features of this device is it does not have to be assembled. Users only have to insert or connect the front base with the back base to use the device.

Another purpose of this invention is to provide a power supply protective device for cars. Compared with the traditional fuse, the thin lock-piece of fuse is simpler and more convenient in use. When taking it out, users only have to use hands and do not need any auxiliary tools.

The power supply protective device for cars described above includes an inserting/connecting section. The front of this section can be inserted into the cigar-lighter base in the car. Its back end has a linking section and inside are several inserting grooves, positive and negative power supply connecting pieces. There is also a thin lock-piece of fuse to be inserted into one of the inserting grooves inside of the inserting section. This arrangement can protect the power supply. In addition, there is an extended part. The front end of this part has linking block corresponding to the linking section. All linking blocks have groove holes so that the power can be directed to the back end of the extension cord when the inserting section is through. Such an arrangement can supply the power needed for electric appliances used in the car and ensure the safety of these appliances.

### BRIEF DESCRIPTION OF THE DRAWINGS

The drawing disclose an illustrative embodiment of the present invent which serves to exemplify the various advantages and objects hereof, and are as follows:

FIG. 1 is a structural disassembled diagram of the invented power supply protective device in cars.

FIG. 2 is the vertical view of the cutaway diagram of the invented power supply protective device in cars.

FIG. 3 is the circuit board and connecting diagram for thin lock-piece fuse of the invented power supply protective device in cars.

FIG. 4 is the diagram for the invented power supply protective device in cars when it is in use.

### SYMBOLS FOR MAJOR PARTS

1 Inserting section

11 Circuit board

12 Linking section

121˜123 Inserting grooves

124, 125 Electrode connecting pieces

2 Thin lock-piece fuse

3 Extended part

31, 32 Linking pieces

311, 312 Groove holes

33 Inserting groove

4 Extension cord

5 Electric appliances

6 Cigar-lighter base in cars

### DETAILED DESCRIPTIONS OF THE PREFERRED EMBODIMENT

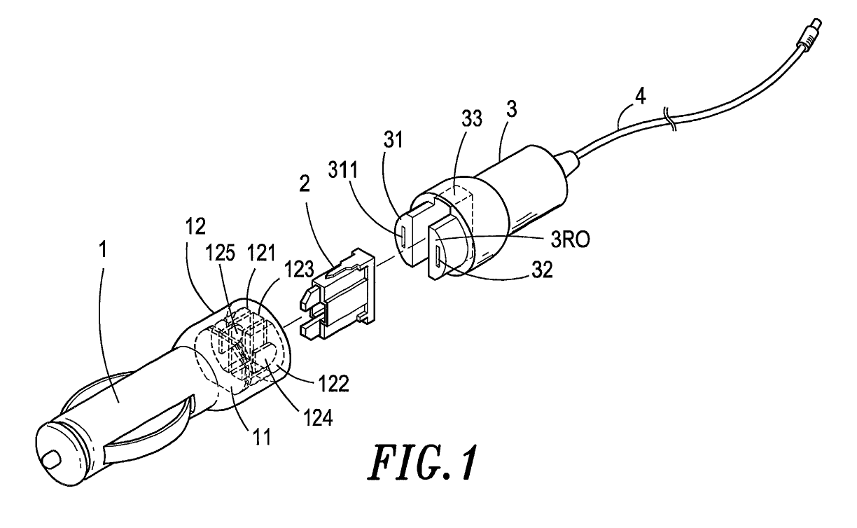

Please refer to FIG. 1. The power supply protective device of cars mentioned in this invention includes the following major parts. First, there is an inserting section (1). The front end of the inserting section (1) can be inserted into the cigar-lighter base in cars. Then, the power will go through the circuit board (11), thin lock-piece fuse (2) and extended part (3) and finally be connected to electric appliances through the extension cord (4). Then, the back end of the above-mentioned inserting section (1) has a linking section (12). Inside the linking section (12) are inserting grooves (121, 122 & 123), positive and negative electrode connecting pieces (124 & 125). When they are connected to the extended part (3), the whole structure is completed. Insert the thin lock-piece fuse (2) into the inserting groove (123) in inserting section (1) to protect electric appliances. Next, there is an extended part (3). Its front end has linking blocks (31 & 32) corresponding to the linking section (12). The linking block has groove holes (311 & 312) and they can direct the power supply that comes in from the inserting section (1) to come out from the extension cord (4). Then, the power can be used by electric appliances used in the car. The extension cord (4) can be connected to different types of plugs according to the users'needs. In the central part of the extension cord, there is an inserting groove (33) to be used to fix the position of the fuse.

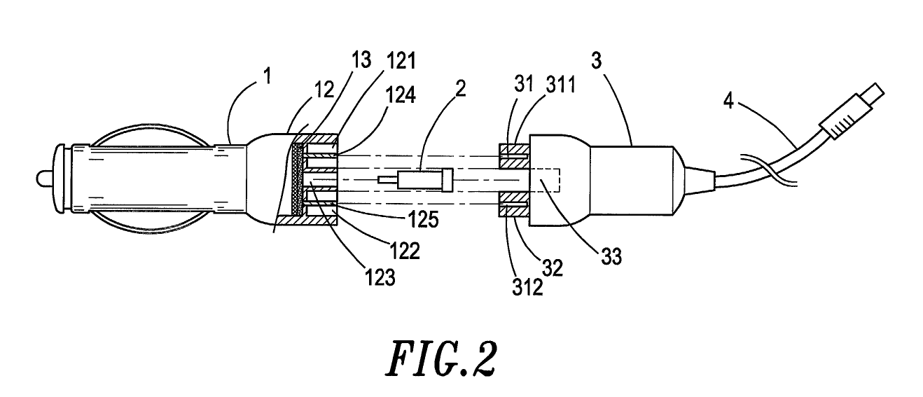

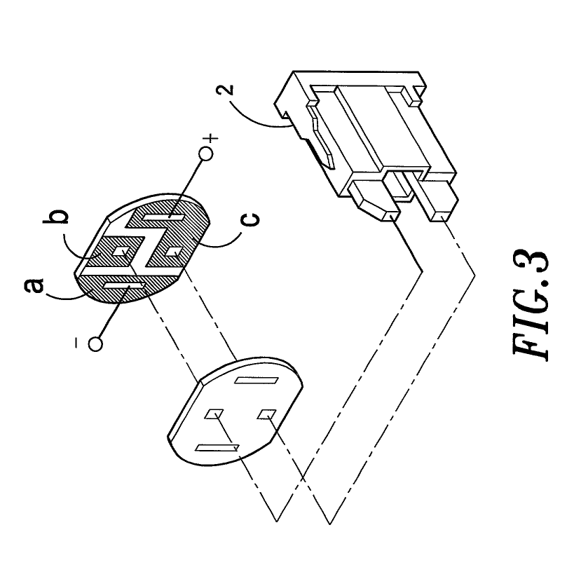

Please refer to FIG. 2. The cutaway diagram shows that the linking section (12) located in the back end of the inserting section (1) has several inserting grooves (121, 122 & 123). On both sides of inserting grooves 121, 122 & 123, there are electrode connecting pieces (124 & 125). These two pieces are connected to an embedded circuit board (13). The thin lock-piece fuse (2) is inserted into the inserting groove 123 located in the middle for power to go through. Please also refer to FIG. 3. The power supply inside the car is connected to connecting points a and b. When the thin lock-piece fuse (2) is inserted, connecting points b and c will immediately be connected and power supply from both positive and negative electrodes will go from connecting points a and c to the connecting pieces 124 and 125. In addition, groove holes (311 & 312) on the linking blocks (31 & 32) at the front end of the extended part (3) have metallic contact inside. Such a contact can direct power to the back end of the extension cord through electrode connecting pieces (124 & 125). Then, this set-up can be used for all kinds of electric appliances. Inserting groove 33 is used to fix the position of the thin lock-piece fuse (2).

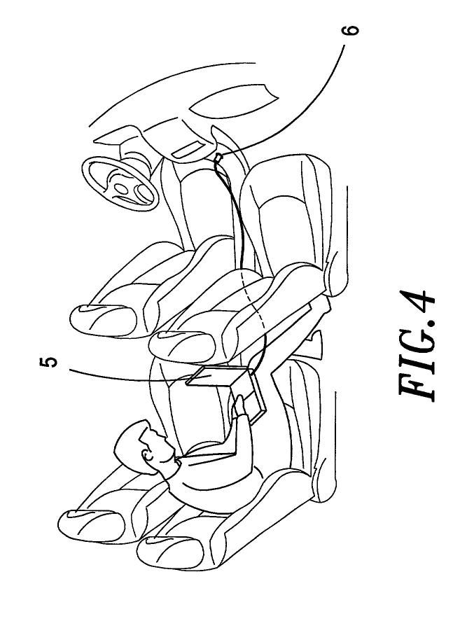

Please refer to FIG. 4. When passengers use electric appliances (5) in their cars, they can obtain power supply from the cigar-lighter base (6). With the protection of this invention, users do not have to worry about possible damages or breakdown and can concentrate on their own work.

This invention of the power supply protective device for cars has following advantages compared with the traditional models.

1. It is very small and easy to carry. Moreover, it is very easy to find a space for its storage.

2. The power cord can be extended unlimitedly. When users go outdoors for picnic, they can extend the cord beyond the car and make its use more diverse. In other words, such power supply becomes portable.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A power supply protective device in cars, comprising:
a front part that can be inserted into the car-lighter base in cars, and a back part that has a linking section, which comprises of several inseting grooves, positive/negative electrode power supply connecting pieces and an inserting part of the circuit board;
a thin lock-piece fuse that can be inserted into one of the inserting groove in the inserting section mentioned above to protect the power source;
there are linking blocks located in the front end to correspond to the linking section, all linking blocks have groove holes, in its center, there is an inserting groove to fix the position of the fuse, there is also an extended part that can direct the power supply to come out from the back end of the extension cord;
the above-mentioned structure is used to protect electric appliances when they are connected to cars.

2. The power supply protective device in cars of claim 1, wherein on the extended section, there is metallic contact inside the groove holes of the front end of the inserting blocks to direct power to go through negative and positive electrodes and go into the back end of the extension cord, so that the power can be used by different electric appliances.

3. The power supply protective device in cars of claim 1, wherein the extension cord can be connected to different types of plugs according to users' needs.
